(19) United States
(12) Patent Application Publication
(10) Pub. No.: US 2025/0206618 A1
(43) Pub. Date: Jun. 26, 2025

(54) Production of Graphite Anode Materials from a Sustainable Source, Anode and Battery Containing Same

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/396,344

(22) Filed: Dec. 26, 2023

(51) Int. Cl. C01B 32/205

(52) U.S. Cl. CPC C01B 32/205; C01P 2002/72; C01P 2002/82; C01P 2006/40

(57) ABSTRACT

A composition of matter comprising a) a catalyst content of between about 0.1 to 20 percent by weight; b) a biochar particulate content of between 65 and 99.8 percent by weight, having a biochar particulate size less than 1 mm; and c) a graphene content of between about 0 and 30 percent by weight (if the catalyst is uniformly coated on the surfaces of biochar particulates) or a graphene content of between about 0.1 and 30 percent by weight; wherein the catalyst comprises a metal, a metal compound, B, P, Sn, or a combination thereof; and the graphene sheets comprise single-layer or few-layer graphene selected from pristine graphene, graphene oxide, reduced graphene oxide, halogenated graphene, nitrogenated graphene, hydrogenated graphene, doped graphene, chemically functionalized graphene, or a combination thereof. Also provided is a method of producing graphite or graphite-based anode materials from this feedstock composition.

### FIELD

The present disclosure relates to the art of graphite-based anode materials and, in particular, to a biochar-based feedstock composition and a method of producing a graphite anode material from such a feedstock.

### BACKGROUND

Carbon is known to have five unique crystalline structures, including diamond, fullerene (0-D nano graphitic material), carbon nano-tube or carbon nano-fiber (1-D nano graphitic material), graphene (2-D nano graphitic material), and graphite (3-D graphitic material). The carbon nano-tube (CNT) refers to a tubular structure grown with a single wall or multi-wall. Carbon nano-tubes (CNTs) and carbon nano-fibers (CNFs) have a diameter on the order of a few nanometers to a few hundred nanometers. Their longitudinal, hollow structures impart unique mechanical, electrical and chemical properties to the material. The CNT or CNF is a one-dimensional nano carbon or 1-D nano graphite material.

Bulk natural graphite powder is a 3-D graphitic material with each graphite particle being composed of multiple grains (a grain being a graphite single crystal or crystallite) with grain boundaries (amorphous or defect zones) demarcating neighboring graphite single crystals. Each grain is composed of multiple graphene planes that are oriented parallel to one another. A graphene plane in a graphite crystallite is composed of carbon atoms occupying a two-dimensional, hexagonal lattice. In a given grain or single crystal, the graphene planes are stacked and bonded via van der Waal forces in the crystallographic c-direction (perpendicular to the graphene plane or basal plane). Although all the graphene planes in one grain are parallel to one another, typically the graphene planes in one grain and the graphene planes in an adjacent grain are different in orientation.

A new class of nano carbon material is graphene, a 2-D material having a hexagonal arrangement of carbon atoms. These honeycomb-like carbon atoms can form a free-standing sheet that is one-atom thick, which is now commonly referred to as a single-layer graphene sheet. Several layers of graphene planes can be bonded together to form a multi-layer graphene sheet or platelets, which contain less than 300 graphene planes or layers (or thinner than 100 nm), preferably less than 20 layers, and further preferably less than 10 layers (few-layer graphene). In both single-layer graphene and multi-layer graphene sheets, the graphene planes or edges can contain some non-carbon elements, such as hydrogen, oxygen, nitrogen, and fluorine, to name just a few. All these single-layer or multi-layer graphene sheets (0.34 nm to 100 nm thick) are herein collectively referred to as nano graphene platelets (NGPs). These include pristine graphene, graphene oxide, reduced graphene oxide, graphene fluoride, nitrogenated graphene, hydrogenated graphene, boron-doped graphene, etc. Graphene sheets can be obtained by exfoliating graphite materials using known processes.

Graphite is generally classified into natural graphite or artificial graphite (also commonly referred to as synthetic graphite). Mining of natural graphite is generally considered as a highly polluting process due to the extensive use of undesirable chemicals. Particles of synthetic or artificial graphite, hard carbons, and soft carbons may be prepared by graphitization of coke, or carbonization and graphitization of an organic synthetic polymeric material, petroleum pitch, coal tar pitch, and the like. However, production of synthetic graphite from the use of large quantities of petroleum or coal feedstock is not generally viewed as environmentally benign. Thus, it is highly desirable to develop eco-friendly, inexpensive carbon or graphite materials with scalable synthesis/fabrication processes from sustainable sources.

Thus, it is an object of the present disclosure to provide a method of cost-effectively producing graphite from a biochar feedstock. The resultant graphite can then be converted into anode active materials for lithium-ion batteries.

### SUMMARY

The present disclosure provides a strikingly simple, fast, scalable, environmentally benign, and cost-effective process or method that meets the afore-mentioned needs. This method is capable of producing a graphite material (in a bulk or powder form) from a biomass or biochar feedstock.

In certain embodiments, the present disclosure provides a composition of matter comprising a mixture of biochar, a catalyst, and discrete graphene sheets; the mixture is intended for use as a feedstock to be converted into a crystalline graphite product. The composition comprises: (a) a catalyst content of between about 0.1 and 30 percent by weight (preferably <20%, further preferably <15%, more preferably <10%, still further preferably <5%); (b) a biochar particulate content of between 65 and 99.8 percent by weight, having a biochar particulate size less than 1 mm (preferably less than 100 μm and most preferably less than 30 μm); and (c) a graphene content either (i) from 0 to 30 percent by weight if the catalyst is in a form of coating uniformly coated on the surfaces of biochar particulates (preferably having a coating thickness from 0.5 nm to 10 μm), or (ii) from about 0.1 to 30 percent by weight; wherein the catalyst comprises a metal, a metal compound, boron (B), phosphorus (P), tin (Sn), or a combination thereof; and the graphene sheets comprise single-layer or few-layer graphene (having 2-10 graphene planes) selected from pristine graphene, having a carbon content greater than 99%, graphene oxide, reduced graphene oxide, halogenated graphene, nitrogenated graphene, hydrogenated graphene, doped graphene, chemically functionalized graphene, or a combination thereof. The particulates can contain chips, granules, pellets, flakes, etc.

In certain embodiments, one or more of the following apply: (i) the catalyst content in the mixture is in particulate form; (ii) the catalyst content in the mixture is in a thin coating form deposited on a surface of the graphene sheets; and (iii) the catalyst content in the mixture is in a thin coating form deposited on a surface of the biochar particulates.

In some preferred embodiments, one or more of the following apply: (i) the graphene content is from about 1 to about 10 percent by weight; (ii) the biochar is from 75 to 99 percent; and (iii) the catalyst content is from 1 to 7 percent. We have discovered that by uniformly coating or encapsulating biochar particulates with a catalyst coating, the proportion of the needed catalyst can be significantly reduced.

The biochar content is preferably obtained by heating a biomass feedstock to temperatures of between about 150 and 1500 degrees Celsius and the biomass feedstock comprises a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof.

The lignocellulosic biomass may be selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methylcellulose, sodium lignosulfonate, Kraft lignin, onion peels, camphor leaves, seaweed, wheat straw, or a combination thereof.

The non-lignocellulosic biomass may be selected from food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, or a combination thereof.

In certain embodiments, one or more of the following apply: (i) the metal, metal alloy, or metal compound comprises a transition metal; and (ii) the metal compound comprises a salt of a transition metal. The transition metal may be selected from chromium, zirconium, molybdenum, ruthenium, rhodium, palladium, silver, cadmium, zinc, copper, nickel, cobalt, iron, manganese, chromium, vanadium and any combination thereof. The transition metal salt may be selected from a metal nitrate, metal acetate, metal sulfate, metal phosphate, metal hydroxide, metal carboxylate, or a combination thereof.

In certain preferred embodiments, the doped graphene comprises graphene sheets doped or coated with element B, P, Sn, Ti, V, Cr, Mn, Fe, Co, Ni, Cu, Zn, Zr, Nb, Mo, Ru, Pd, Ag, Cd, Pt, Au, a chemical species selected from PdCl₂, FeCl₃, FeBr₃, FeF₃, NiBr₂, NiI₂, Cs₂CO₃, CsF, CsCl, CsBr, CH₂Cl₂, FeSiO₃, CuSiF₆, CuCl₂, CuF₂, CuO, B₄C, or a combination thereof.

The composition may have one or more of the following features: (i) the biochar component has a particulate size of less than about 0.5 mm (preferably less than 100 μm, further preferably less than 50 μm, and most preferably less than 30 μm); and (ii) the catalyst component has a particulate size or coating thickness of less than about 5 μm. The catalyst coating preferably has a size from 0.5 nm to 1 μm.

In certain embodiments, the disclosure provides a method of producing crystalline graphite and graphite-based anode active material. The method of producing crystalline graphite from the aforementioned composition (as a feedstock material) comprises: (A) providing a composition, comprising a mixture of biochar, a catalyst, and discrete graphene sheets, wherein the graphene sheets comprise single-layer or few-layer graphene selected from pristine graphene, having a carbon content greater than 99%, graphene oxide, reduced graphene oxide, halogenated graphene, nitrogenated graphene, hydrogenated graphene, doped graphene, chemically functionalized graphene, or a combination thereof; and (B) heat-treating the composition at a graphitization temperature for a period of time sufficient to produce a crystalline graphite product having a graphite content higher than 65% by weight (typically from 85 to essentially 100%), wherein the graphitization temperature is selected from 400° C. to 3,200° C. and the graphitization heat is not mainly from laser irradiation or is free from laser irradiation.

The catalyst may comprise an element or chemical species selected from B, P, Sn, N, Ti, V, Cr, Mn, Fe, Co, Ni, Cu, Zn, Zr, Nb, Mo, Ru, Pd, Ag, Cd, Pt, Au, PdCl₂, FeCl₃, FeBr₃, FeF₃, NiBr₂, NiI₂, Cs₂CO₃, CsF, CsCl, CsBr, CH₂Cl₂, FeSiO₃, CuSiF₆, CuCl₂, CuF₂, CuO, B₄C, a metal nitrate, metal acetate, metal sulfate, metal phosphate, metal hydroxide, metal carboxylate, or a combination thereof.

The catalyst is preferably coated on surfaces of biochar particulates or on surfaces of the graphene sheets, wherein the graphene sheets have a specific surface area from 20 to 3,200 m²/g when measured without the presence of the catalyst.

The catalytic metal-coated graphene sheets and/or biochar particulates may be produced by a process comprising (a) dissolving or dispersing a metal compound in a liquid medium to form a precursor solution, wherein the metal compound is selected from a metal nitrate, metal acetate, metal sulfate, metal phosphate, metal hydroxide, metal carboxylate, or a combination thereof; (b) dispersing graphene sheets and/or biochar particulates in the precursor solution to form a slurry; (c) drying or removing the liquid medium from the slurry to form a dry mass of catalytic metal compound-coated graphene sheets and/or biochar particulates; and (d) heating the dry mass to decompose or reduce the metal compound into metal to form the catalytic metal-coated graphene sheets and/or biochar particulates.

In certain embodiments, the surfaces of the biochar and/or the surfaces of graphene sheets are coated with a polynuclear hydrocarbon material. In certain embodiments, the mixture composition may be further mixed with a polynuclear hydrocarbon material. Polynuclear hydrocarbons (also referred to as polycyclic aromatic hydrocarbons, PAHs, polyaromatic hydrocarbons, or polynuclear aromatic hydrocarbons) are hydrocarbons (organic compounds containing mostly carbon and hydrogen) that are essentially composed of multiple aromatic rings fused together (fused organic rings in which the electrons are delocalized). Preferably, the polynuclear hydrocarbon material is selected from the group consisting of and non-halogenated versions of naphthalene, anthracene, phenanthrene, tetracene, chrysene, triphenylene, pyrene, pentacene, benzo-pyrene, corannulene, benzo-perylene, coronene, ovalene, benzo-fluorene, petroleum pitch, coal tar pitch, halogenated versions thereof, chemical derivatives thereof, and combinations thereof.

In some embodiments, the biochar particulates may be produced from thermally treating biomass in water in a hydrothermal carbonization step. In alternative embodiments, the biochar particulates are produced from thermally treating biomass under inert conditions in a dry pyrolysis step.

The chemically functionalized graphene may comprise a functional group selected from —OH, —COOH, —NH₂, —C═O, or a combination thereof

The graphitization temperature is preferably selected from 500° C. to 2,500° C., more preferably from 1,000° C. to 2,000° C.

The crystalline graphite produced by using this method typically contains graphite crystals having a length or width from 10 nm to 10 μm or an inter-graphene spacing from 0.335 nm to 0.38 nm. The graphite typically exhibits a degree of graphitization no less than 80%, more often greater than 90%.

The crystalline graphite product produced by this method typically comprises less than 5% by weight of non-graphitized biochar, more typically less than 1%.

In some preferred embodiments, the method has at least one of the following features:
(i) the method further comprises a procedure of removing the catalyst from the crystalline graphite product after the formation of this graphite product;
(ii) the crystalline graphite product contains a residual catalyst metal or Sn and the method further comprises a procedure of oxidizing the residual metal or Sn to form a metal oxide (e.g., cobalt oxide, manganese oxide, titanium oxide, niobium oxide, nickel oxide, etc.) or SnO₂ that is mixed with the crystalline graphite; these tin oxide and metal oxides in the resulting oxide/graphite composites can deliver a significantly higher specific capacity, from the typically 260-360 mAh/g of the neat graphite (graphite only) to 400-800 mAh/g;
(iii) the crystalline graphite product is pulverized to form particulates having a size smaller than 30 μm (preferably smaller than 20 μm, and further preferably smaller than 10 μm); and
(iv) encapsulating or coating crystalline graphite particulates with a carbon shell to form an anode active material; this can be accomplished by mixing the graphite particles with a carbon precursor material (e.g., a bio-pitch, coal tar pitch, petroleum pitch, a polymer, etc.) to form precursor-coated graphite particles, followed by a heat treatment at a temperature from 350 to 3,000° C., typically less than 1,600° C.

Thus, the disclosure also provides a method of producing a crystalline graphite-based anode material, said method comprising (a) providing a feedstock mixture comprising particles of biomass and/or biochar and from 0.1% to 40% by weight of a catalyst, wherein the catalyst is selected from Sn, a Sn alloy, a transition metal, a transition metal alloy, a compound containing Sn, a compound comprising a transition metal, or a combination thereof; (b) heat-treating the feedstock mixture at a graphitization temperature for a period of time sufficient to produce a crystalline graphite product comprising a mixture of Sn or the transition metal and crystalline graphite, wherein the graphitization temperature is selected from 400° C. to 3,200° C.; and (c) converting Sn or the transition metal to SnO₂ or transition metal oxide to produce the desired anode material comprising crystalline graphite and SnO₂ or transition metal oxide.

In some embodiments, the feedstock mixture comprises from 1% to 20% by weight of the catalyst. The transition metal is preferably selected from Ti, V, Cr, Mn, Fe, Co, Ni, Cu, Zn, Zr, Nb, Mo, Ru, Pd, Ag, Cd, Pt, Au, or a combination thereof. The anode material produced using this method, when used in a lithium-ion cell, delivers a specific capacity value (in terms of mAh/g) higher than a specific capacity of the crystalline graphite alone without the metal oxide or SnO₂.

The disclosed production method leads to a unique product composition. Thus, the present disclosure also provides a composition of matter comprising a mixture of crystalline graphite, a catalyst metal, isolated graphene sheets (not part of a graphite structure), and biochar, with (a) a crystalline graphite content of from about 70% to 99% by weight, (b) a metal content from about 0.1% to about 15% by weight, (c) a biochar content from about 0.1% to about 10% by weight, and (d) isolated graphene sheet content from about 0.1% to about 5% by weight.

The composition may have one or more of the following features: (i) the crystalline content in the mixture is in particulate form (typically smaller than 100 μm in size, more preferably and typically smaller than 30 μm, and further preferably smaller than 20 μm); (ii) the biochar content in the mixture is in particulate form having a size smaller than 500 μm; (iii) the metal content comprises metal on a graphite surface or embedded in a graphite particulate; and (iv) the metal content in the mixture comprises a metal oxide.

In some embodiments, the composition has one or more of the following features: (i) the crystalline graphite content is greater than 75% by weight; (ii) the biochar content is less than 5%; and (iii) the metal content is less than 5%.

As compared to conventional processes, the presently disclosed method desirably involves significantly shorter preparation and heat treatment times and lower amounts of energy consumed, yet resulting in graphite materials that are of comparable or even higher degree of graphitization and, hence, higher thermal conductivity, higher electrical conductivity, and higher reversible specific capacity when used as an anode active material.

### BRIEF DESCRIPTION OF THE DRAWINGS

FIG. 1(A) A flow chart showing the production of crystalline graphite from pieces (particles) of biochar, catalyst, and isolated graphene sheets, according to certain embodiments of the present disclosure;

FIG. 1(B) A flow chart showing the production of catalyst-coated graphene sheets or catalyst-coated biochar particulates according to some preferred embodiments of the present disclosure.

FIG. 2(A) An X-ray diffraction (XRD) curve of a graphitic material used to illustrate the procedure for calculating the degree of graphitization;

FIG. 2(B) Raman spectroscopy of a graphitic material used to illustrate the procedure for calculating the degree of graphitization.

### DETAILED DESCRIPTION

The disclosure provides a method of producing crystalline graphite-based anode materials from a feedstock composition comprising biochar particulates (chips, granules, pellets, etc.), graphene sheets, and a catalyst in the form of particulates or coating deposited on the surfaces of biochar particulates and/or surfaces of graphene sheets. The feedstock composition of matter is herein described first.

In certain embodiments, the present disclosure provides a composition of matter comprising a mixture of biochar, a catalyst, and discrete graphene sheets; the mixture is intended for use as a feedstock to be converted into a crystalline graphite product. The feedstock composition comprises: (a) a catalyst content of between about 0.1 and 30 percent by weight (preferably <20%, further preferably <15%, more preferably <10%, still further preferably <5%); (b) a biochar particulate content of between 65 and 99.8 percent by weight, having a biochar particulate size less than 1 mm (preferably less than 100 μm and most preferably less than 30 μm); and (c) a graphene content of either (i) from 0 to 30 percent by weight (if the catalyst is in a form of coating uniformly coated on the surfaces of biochar particulates, preferably having a coating thickness from 0.5 nm to 100 μm) or (ii) from about 0.1 to 30 percent by weight (regardless the form of the catalyst, particulate or coating); wherein the catalyst comprises a metal, a metal alloy, a metal compound, boron (B), phosphorus (P), tin (Sn), or a combination thereof; and the graphene sheets comprise single-layer or few-layer graphene (having 2-10 graphene planes) selected from pristine graphene, having a carbon content greater than 99%, graphene oxide, reduced graphene oxide, halogenated graphene, nitrogenated graphene, hydrogenated graphene, doped graphene, chemically functionalized graphene, or a combination thereof.

High-quality crystalline graphite can be produced by heat-treating this feedstock composition at a graphitization temperature for a period of time sufficient to produce a crystalline graphite product having a graphite content higher than 65% by weight (typically >75% and more typically from 85 to essentially 100%), wherein the graphitization temperature is selected from 400° C. to 3,200° C. Preferably, the graphitization heat is not mainly from laser irradiation or is totally free from laser irradiation.

In certain embodiments, one or more of the following apply: (i) the catalyst content in the mixture is in particulate form; (ii) the catalyst content in the mixture is in a thin coating form (e.g., having a coating thickness from 0.5 nm to 100 μm, preferably <10 μm) deposited on surfaces of the graphene sheets; and (iii) the catalyst content in the mixture is in a thin coating form deposited on surfaces of the biochar particulates.

The catalyst described in the instant disclosure was found to be very effective in reducing the graphitization temperature of a carbonaceous material (e.g., biochar) from a typically 2,500-3,500° C. to typically below 2,200° C. (more typically below 2,000° C.). The graphitization time can be reduced from weeks or days to hours. It was further discovered that a uniform dispersion or distribution of the catalyst in the mixture composition was critical to the successful conversion of substantially all of the biochar content into crystalline graphite, typically leaving behind less than 10% of un-graphitized biochar (when the catalyst is in a particulate form) and typically less than 5% or even less than 1% of un-graphitized biochar (when substantially all biochar particulates are coated with a desired amount of catalyst coating). This is in stark contrast to a typically 15%-35% by weight of biochar remaining un-graphitized in a conventional catalytic graphitization process. It was also observed that a much lower amount of catalyst could be used when the biochar particulates are pre-coated with a thin coating layer of the catalyst. In this catalyst coating strategy, typically a catalyst proportion of less than 15% (more typically <10%, further typically <5%, and often <2%) in the feedstock composition was sufficient to catalyze the graphitization of substantially all the biochar particulates. This would also significantly reduce the amount of chemicals, time, and cost associated with the subsequent removal of residual catalyst from the graphite to be used for an anode active material.

We have surprisingly observed that graphene sheets can improve the degree of graphitization of the resultant graphite, substantially crystalline graphite. The graphene sheets appear to serve as seeds for promoting growth of graphite crystals. Graphene sheets provide exceptionally high specific surface areas to support the catalyst coating, enabling more areas of contact between the catalyst and the biochar in a feedstock composition. This could improve the graphitization efficiency, allowing substantially all of the biochar particulates to be completely graphitized.

The biochar particulates may be produced from thermally treating biomass in water in a hydrothermal carbonization step. Alternatively, the biochar particulates may be produced from thermally treating biomass under inert conditions in a dry pyrolysis step. Both hydrothermal carbonization and pyrolysis are well known in the art. The carbonization and graphitization is preferably conducted in a non-oxidizing environment, preferably in vacuum or in a protective atmosphere (e.g., an inert gas and/or N2 gas). In some embodiments, carbonization may be conducted under a pressure of 20 Psi to 1200 Psi (1 Psi=6.89 kPa). Other methods of producing biochar from biomass can also be practiced; there are no restrictions on how biochar can be produced.

The biomass feedstock for biochar production may comprise a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof. The lignocellulosic biomass is the most abundant non-edible type of biomass from forestry and agricultural wastes, and includes mainly three different components, including cellulose, hemicellulose and lignin. The non-lignocellulosic biomass (e.g., fruit waste and food waste) is rich in carbohydrates, polysaccharides and protein.

The lignocellulosic biomass may be selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methylcellulose, sodium lignosulfonate, Kraft lignin, onion peels, camphor leaves, seaweed, wheat straw, etc. The non-lignocellulosic biomass may include food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, etc.

As non-limiting examples, some of the biomass species that can be processed to produce biochar are rice husk, recycled paper cup, hemp, shrimp or other types of soft shells, willow catkins, corn stalk, corn powder, corn cob, coconut shell, wheat straw, spruce bark, camphor leaves, banana peel, copinus comatus, nori, honey suckles, waste peanut shell, eggplant, wood chips, seaweed, soya bean, glucose, etc. This list is meant to illustrate the fact that a wide variety of sustainable products can be used and processed into graphene sheets. One can even convert agricultural and wood waste into highly valuable products.

In certain desired embodiments, the biomass particles comprise a biomass waste. The biomass may comprise multiple types of biomass species that are mixed together.

The disclosed composition may have one or more of the following features: (i) the metal, metal alloy, or metal compound comprises a transition metal; and (ii) the metal compound comprises a salt of a transition metal. The transition metal may be selected from chromium, zirconium, molybdenum, ruthenium, rhodium, palladium, silver, cadmium, zinc, copper, nickel, cobalt, iron, manganese, chromium, vanadium and any combination thereof. The transition metal salt may be selected from a metal nitrate, metal acetate, metal sulfate, metal phosphate, metal hydroxide, metal carboxylate, or a combination thereof.

The doped graphene comprises graphene sheets doped or coated with element B, P, Sn, Ti, V, Cr, Mn, Fe, Co, Ni, Cu, Zn, Zr, Nb, Mo, Ru, Pd, Ag, Cd, Pt, Au, a chemical species selected from PdCl₂, FeCl₃, FeBr₃, FeF₃, NiBr₂, NiI₂, Cs₂CO₃, CsF, CsCl, CsBr, CH₂Cl₂, FeSiO₃, CuSiF₆, CuCl₂, CuF₂, CuO, B₄C, or a combination thereof. The graphene sheets having an exceptionally high specific surface area are capable of more uniformly dispersing these elements and allowing more of the atoms to be in contact with the constituent carbonaceous material (biochar) and/or growing graphite crystals.

The composition may have one or more of the following features: (i) the biochar component has a particulate size of less than about 0.5 mm (preferably less than 100 μm, further preferably less than 50 μm, and most preferably less than 30 μm); and (ii) the catalyst component has a particulate size or coating thickness of less than about 10 μm, preferably less than 5 μm. The catalyst coating preferably has a size from 0.5 nm to 1 μm.

The feedstock composition may comprise a catalyst that comprises B, P, Sn, a transition metal selected from Ti, V, Cr, Mn, Fe, Co, Ni, Cu, Zn, Zr, Nb, Mo, Ru, Pd, Ag, Cd, Pt, Au, a combination thereof, or wherein the catalyst contains a chemical species selected from PdCl₂, FeCl₃, FeBr₃, FeF₃, NiBr₂, NiI₂, Cs₂CO₃, CsF, CsCl, CsBr, CH₂CL₂, FeSiO₃, CuSiF₆, CuCl₂, CuF₂, CuO, B₄C, or a combination thereof. The catalyst is preferably coated on surfaces of biochar particles and/or graphene sheets.

The chemically functionalized graphene may comprise a functional group selected from —OH, —COOH, —NH₂, —C═O, or a combination thereof

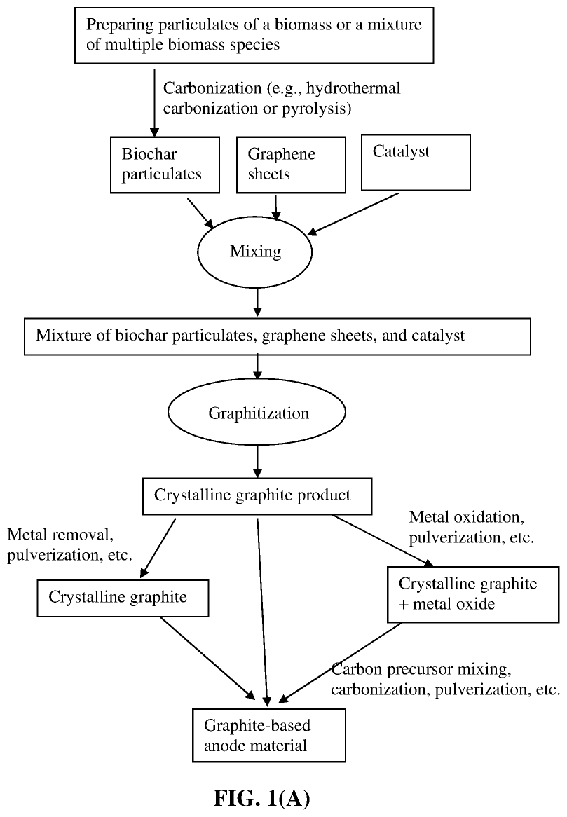

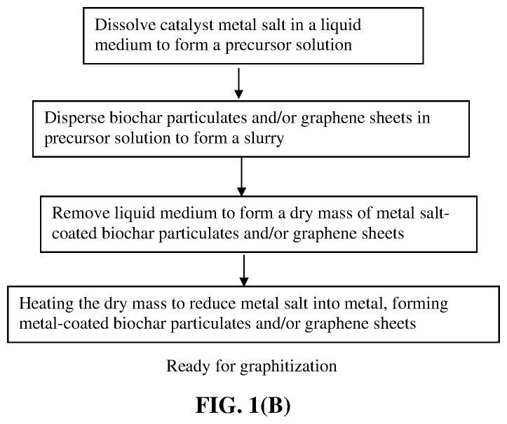

The disclosure also provides a method of producing crystalline graphite and graphite-based anode active material, as schematically illustrated in FIG. 1(A). The method of producing crystalline graphite from the aforementioned composition (as a feedstock material) comprises: (A) providing a composition, comprising a mixture of biochar, a catalyst, and discrete graphene sheets at desired weight ratios, wherein the graphene sheets comprise single-layer or few-layer graphene selected from pristine graphene, having a carbon content greater than 99%, graphene oxide, reduced graphene oxide, halogenated graphene, nitrogenated graphene, hydrogenated graphene, doped graphene, chemically functionalized graphene, or a combination thereof; and (B) heat-treating the composition at a graphitization temperature for a period of time sufficient to produce a crystalline graphite product having a graphite content higher than 65% by weight (typically >75%, and more typically from 85 to essentially 100%), wherein the graphitization temperature is selected from 400° C. to 3,200° C. and the graphitization heat is not mainly from laser irradiation or is totally free from laser irradiation. Laser irradiation is too spatially focused, limited to a small heating spots at a given moment of time. Laser irradiation is not suitable for large-scale production of graphite from biochar.

The crystalline graphite produced by using this method typically contains graphite crystals having a length or width from 10 nm to 10 μm or an inter-graphene spacing from 0.335 nm to 0.38 nm. The graphite typically exhibits a degree of graphitization no less than 80%.

A graphene sheet or nano graphene platelet (NGP) is essentially composed of a graphene plane (hexagonal lattice of carbon atoms) or multiple graphene planes stacked and bonded together (typically up to 10 graphene planes per multi-layer platelet). Each graphene plane, also referred to as a graphene sheet, comprises a two-dimensional hexagonal structure of carbon atoms. Each platelet has a length and a width parallel to the graphene plane and a thickness orthogonal to the graphene plane. By definition, the thickness of an NGP can be 100 nanometers (nm) or smaller (preferably containing no greater than 10 hexagonal planes), with a single-sheet NGP, also referred to as single-layer graphene, being as thin as 0.34 nm.

The methods of producing pristine graphene, graphene oxide (GO), reduced graphene oxide (RGO), halogenated graphene (graphene bromide, graphene fluoride, graphene chloride, graphene iodized, or a combination thereof), nitrogenated graphene, hydrogenated graphene, doped graphene, and chemically functionalized graphene are well known in the art. However, it has not been known in the art that various different graphene sheets are capable of improving the chemical conversion of biochar into graphite in terms of increasing the degree of graphitization of the resultant graphite materials.

Degree of graphitization (G) may be measured using X-ray diffraction (XRD) or Raman spectroscopy method. A material with high degree of graphitization will have a structure with well-ordered graphite like form with sp2 hybridized carbon atoms assembled in a planar hexagonal lattice. Therefore, such material will exhibit good mechanical properties with high electrical and thermal conductivity.

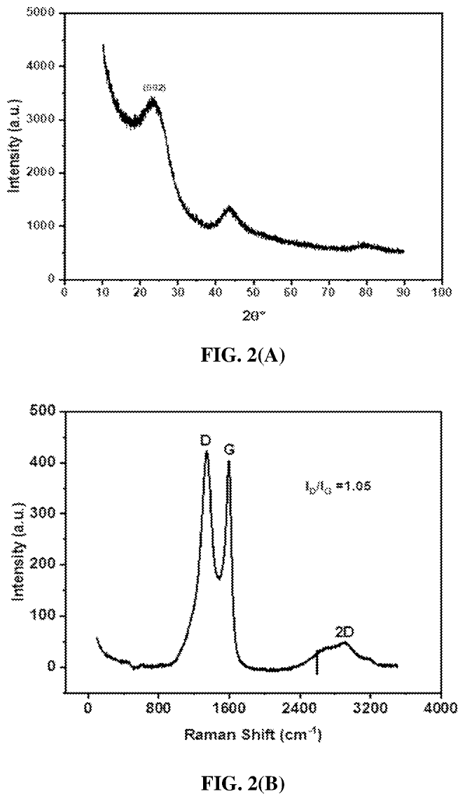

The XRD data (e.g., as illustrated in FIG. 2(A)) can be used to calculate the degree of graphitization (G) from the interplanar spacing (d) using the below equation:

$$G = \frac{{d}_{002} - {d}_{002 sample}}{{d}_{002} - {d}_{graphite}}$$

Where d₀₀₂ can be estimated from Bragg equation:

$${d}_{002} = \frac{λ}{2 sin {θ}_{002}}$$

d₀₀₂ is the interplanar spacing of the (002) XRD peak in graphite 0.3440, d(sample) is the interplanar spacing of the (002) XRD peak of the sample, and d(graphite) is the interplanar spacing of the (002) XRD peak of the highly ordered graphite. The value of d(graphite) is known and can be used as a reference for determining the degree of graphitization of other carbon materials. For highly ordered graphite, d (002) is around 0.3354 nm. Thus, we have

$$G = \frac{0.3440 - {d}_{002 sample}}{0.3440 - 0.3354} ,$$

which is commonly referred to as the Mering's Eq,

Raman spectroscopy can also be used to study the degree of graphitization of carbon materials as it provides useful information on the structural and electronic properties of the carbon material. Carbon material with high degree of graphitization has a structure with well-ordered graphite like form with sp2 hybridized carbon atoms assembled in a planar hexagonal lattice. As a result, sharp and high intensity Raman signals corresponding to the characteristic G and 2D bands of graphitic carbon can be observed along with a weak Raman signal corresponding to the characteristic D (illustrated in FIG. 2(B)). The intensity of D/G ratio provides information about the degree of graphitization. While the lower value of the ID/IG suggests a high degree of graphitization, the high value ID/IG ratio indicates a more disordered or amorphous structure.

Graphene sheets may be internally doped or surface-coated with element B, P, Ti, V, Cr, Mn, Fe, Co, Ni, Cu, Zn, Zr, Nb, Mo, Ru, Pd, Ag, Cd, Pt, Au, or a combination thereof. Internal doping may be accomplished by ion implementation (e.g., B ion implementation). Surface coating of the aforementioned elements may be conducted by using physical vapor deposition, chemical vapor deposition, sputtering, solution deposition, etc. The graphene sheets having an exceptionally high specific surface area are capable of more uniformly dispersing these elements and allowing more of the atoms to be in contact with the constituent biomass, carbonaceous material, and/or growing graphite crystals.

The graphene/biochar mixture may further comprise a catalyst that comprises B, P, N, Sn, a transition metal selected from Ti, V, Cr, Mn, Fe, Co, Ni, Cu, Zn, Zr, Nb, Mo, Ru, Pd, Ag, Cd, Pt, Au, a combination thereof, or wherein the catalyst contains a chemical species selected from PdCl₂, FeCl₃, FeBr₃, FeF₃, NiBr₂, NiI₂, Cs₂CO₃, CsF, CsCl, CsBr, CH₂CL₂, FeSiO₃, CuSiF₆, CuCl₂, CuF₂, CuO, B₄C, or a combination thereof. These chemical species may be sprayed over or coated on the surfaces of the biochar particles and/or the surfaces of graphene sheets.

As illustrated in FIG. 1(B), the catalytic metal-coated graphene sheets and/or metal-coated biochar particulates may be produced by a process comprising: (a) dissolving or dispersing a metal compound in a liquid medium to form a precursor solution, wherein the metal compound is selected from a metal nitrate, metal acetate, metal sulfate, metal phosphate, metal hydroxide, metal carboxylate, or a combination thereof (dissolving iron nitrate or nickel acetate in water to form a solution); (b) dispersing graphene sheets and/or biochar particulates in the precursor solution to form a slurry; (c) drying or removing the liquid medium from the slurry to form a dry mass of catalytic metal compound-coated graphene sheets and/or biochar particulates; and (d) heating the dry mass to decompose or reduce the metal compound (at a temperature of typically 200-1,000° C., typically for a duration of time from 20 minutes to 6 hours) into metal to form the catalytic metal-coated graphene sheets and/or biochar particulates.

In some embodiments of the present disclosure, the surfaces of the biochar particles and/or the surfaces of graphene sheets may be coated with a polynuclear hydrocarbon material. Alternatively, a polynuclear hydrocarbon material may be introduced as a vapor into the heat treatment chamber of graphite production. We have surprisingly observed that such a polynuclear hydrocarbon material behaves like a catalyst or a graphitization promoter. Polynuclear hydrocarbons (also referred to as polycyclic aromatic hydrocarbons, PAHs, polyaromatic hydrocarbons, or polynuclear aromatic hydrocarbons) are hydrocarbons (organic compounds containing mostly carbon and hydrogen) that are essentially composed of multiple aromatic rings fused together (fused organic rings in which the electrons are delocalized).

Prior to the first heat treatment, the starting PAHs contain mostly or substantially all fused rings (e.g., chlorinated anthracene). Although not preferred, the starting aromatic materials in the instant process may be selected from those containing isolated benzene rings that are connected by a linear chain or bond (e.g., 2′-chloro-1,1′:4′,1″-terphenyl). Herein, PAHs include those having further branching substituents on these ring structures. The simplest of such chemicals are naphthalene, having two aromatic rings, and the three-ring compounds anthracene and phenanthrene. Briefly, examples of PAHs are halogenated and non-halogenated versions of naphthalene, anthracene, phenanthrene, tetracene, chrysene, triphenylene, pyrene, pentacene, benzo-pyrene, corannulene, benzo-perylene, coronene, ovalene, and benzo-fluorene. PAHs of interest here typically have from 2 to 20 aromatic rings (approximately 10 to 60 carbon atoms) fused together, more typically from 2 to 10 rings (approximately 10 to 32 carbon atoms). However, they can have a larger number of fused rings or fused polycyclic aromatics.

Petroleum- or coal-derived pitch is a mixture of larger polynuclear hydrocarbons with an average molecular weight of approximately 200 amu (approximately 180-200 carbon atoms or 60-66 rings). Each pitch product is a mixture of many different types and sizes of polynuclear hydrocarbons. There are also a variety of impurities (1-10% by weight) in such pitch materials. In contrast, those PAHs mentioned above are substantially impurity-free. At a graphitization temperature, graphene sheets appear to be capable of promoting growth of graphite crystals. The presence of PAH molecules presumably provides readily formed rings to be merged with growing honeycomb-like (hexagonal) planes.

The method, after graphitization step, may further comprise a procedure of removing the catalyst from the crystalline graphite product after the formation of this graphite product, if so desired. Removal of metal from a mixture may be conducted by any well-known chemical etching procedure, physical separation, etc.

The crystalline graphite product may contain a residual catalyst metal (e.g., transition metal) or Sn and the method may further comprise a procedure of oxidizing the residual metal or Sn to form a metal oxide (e.g., cobalt oxide, manganese oxide, titanium oxide, niobium oxide, nickel oxide, etc.) or SnO₂ that is mixed with the crystalline graphite. These tin oxide and metal oxides (e.g., Co₃O₄) in the resulting oxide/graphite composites, when used as an anode active material in a lithium-ion cell, can deliver a significantly higher specific capacity, from the typically 260-360 mAh/g of the neat graphite (graphite only) to 400-800 mAh/g;

The crystalline graphite product, before or after metal removal, may be pulverized to form particulates having a size smaller than 30 μm (preferably smaller than 20 μm, and further preferably smaller than 10 μm).

It may be beneficial to encapsulate or coat crystalline graphite particulates with a carbon shell to form an anode active material. This can be accomplished by mixing the graphite particles with a carbon precursor material (e.g., a bio-pitch, coal tar pitch, petroleum pitch, polymer, sugar, etc.) to form precursor-coated graphite particles, followed by a heat treatment at a temperature from 350 to 3,000° C. (typically less than 1,600° C., but can be further treated at higher temperatures).

The disclosed production method leads to a unique product composition, which can be a mixture of multiple ingredients. Briefly, the present disclosure also provides a composition of matter comprising a mixture of crystalline graphite, a catalyst metal, biochar, and isolated graphene sheets (which are not part of a graphite structure). This product composition typically comprises (a) a crystalline graphite content of from about 70% to 99% by weight, (b) a metal content from about 0.1% to about 15% by weight, (c) a biochar content from about 0.1% to about 10% by weight, and (d) isolated graphene sheet content from about 0.1% to about 5% by weight.

The composition may have one or more of the following features: (i) the crystalline content in the mixture is in particulate form (typically smaller than 100 μm in size, more preferably and typically smaller than 30 μm, and further preferably smaller than 20 μm); (ii) the biochar content in the mixture is in particulate form having a size smaller than 500 μm; (iii) the metal content comprises metal on a graphite surface or embedded in a graphite particulate; and (iv) the metal content in the mixture comprises a metal oxide.

In some embodiments, the composition has one or more of the following features: (i) the crystalline graphite content is greater than 75% by weight; (ii) the biochar content is less than 5% (often less than 1%); and (iii) the metal content is less than 5%.

As compared to conventional processes, the presently disclosed method desirably involves significantly shorter preparation and heat treatment times and lower amounts of energy consumed, yet resulting in graphite materials that are of comparable or even higher degree of graphitization and, hence, higher thermal conductivity, higher electrical conductivity, and higher reversible specific capacity when used as an anode active material.

The disclosure also provides a method of producing a crystalline graphite-based anode material, the method comprising (a) providing a feedstock mixture comprising particles of biomass and/or biochar and from 0.1% to 40% by weight of a catalyst, wherein the catalyst is selected from Sn, a Sn alloy, a transition metal, a transition metal alloy, a compound containing Sn, a compound comprising a transition metal, or a combination thereof; (b) heat-treating the feedstock mixture at a graphitization temperature for a period of time sufficient to produce a crystalline graphite product comprising a mixture of Sn or the transition metal (e.g., Mn or Co) and crystalline graphite, wherein the graphitization temperature is selected from 400° C. to 3,200° C.; and (c) converting the Sn or transition metal to SnO₂ or a transition metal oxide (e.g., Mn₃O₄ and Co₃O₄) to produce said anode material comprising crystalline graphite and the transition metal oxide or SnO₂. The anode material, when used in a lithium-ion cell, delivers a specific capacity value higher than a specific capacity of the crystalline graphite without the metal oxide or SnO₂.

The feedstock mixture may comprise from 1% to 20% by weight of the catalyst and/or the transition metal is selected from Ti, V, Cr, Mn, Fe, Co, Ni, Cu, Zn, Zr, Nb, Mo, Ru, Pd, Ag, Cd, Pt, Au, or a combination thereof.

The disclosure also provides a composition of matter comprising a mixture of crystalline graphite, a catalyst metal, isolated graphene sheets (which are not part of a graphite structure), and biochar, with (a) a crystalline graphite content of from about 70% to 99% by weight, (b) a metal content from about 0.1% to about 15% by weight, (c) a biochar content from about 0.1% to about 10% by weight, and (d) isolated graphene sheet content from about 0.1% to about 5% by weight.

Preferably, one or more of the following apply: (i) the crystalline graphite content in the mixture is in particulate form; (ii) the biochar content in the mixture is in particulate form having a size smaller than 500 μm; (iii) the metal content comprises metal on a graphite surface or embedded in a graphite particulate; and (iv) the metal content in the mixture comprises a metal oxide. Further preferably, one or more of the following apply: (i) the crystalline graphite content is greater than 75% by weight; (ii) the biochar content is less than 5%; and (iii) the metal content is less than 5%.

The following examples serve to provide the best modes of practice for the presently disclosed method and should not be construed as limiting the scope of the process:

### Example 1: Preparation of Discrete GO Sheets and GO-Assisted and/or Catalytic Graphitization of Non-Lignocellulosic Biomass (e.g., Fruit)

Natural graphite particles with an average diameter of 16 μm were used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven at 80° C. for 24 h. Then, a mixture of concentrated sulfuric acid, fuming nitric acid, and potassium permanganate (at a weight ratio of 4:1:0.05) was slowly added, under appropriate cooling and stirring, to a three-neck flask containing graphite particles. After 4-12 hours of reaction, the acid-treated natural graphite particles were filtered and washed thoroughly with deionized water until the pH level of the solution reached 6. After being dried at 100° C. overnight, the resulting graphite intercalation compound (GIC) or graphite oxide was exfoliated in an oven pre-set at 1,050° C. for 2 minutes to obtain graphene oxide (GO) sheets.

Production of biochar: Biochar was made by heat treating fruit-based non-lignocellulosic biomass with the assistance of B-coated GO sheets. In one example (Sample 1-D), surfaces of GO sheets were bonded with amorphous boron (B) particles. This was accomplished by dispersing Go sheets and B particles in an adhesive solution, followed by drying the slurry in a vacuum oven over night. The biomass particles and GO sheets (with or without B) were mixed and subjected to hydrothermal carbonization treatments to obtain biochar. In a comparative sample, no GO sheets were implemented.

The fruits of glossy privet were washed and dried at 80° C. for 6 h. Then, the B-coated GO sheets and the fruits (22.328 g) were put into an autoclave (0.5 L) containing deionized water (200 mL), where the GO-to-fruit mass ratios were 1/100 and 1/10 in two separate samples. The autoclave was subjected to a hydrothermal reaction at 350° C. for 2 h. A dark-brown biochar solid was obtained by filtrating, washing with deionized water until reaching a neutral state, followed by drying at 70° C. for 3 h.

Production of graphite: Subsequently, two groups of samples were prepared, one containing iron nitrate as a precursor to a Fe-based catalyst to catalyze the graphitization and the other containing no metal catalyst. In the first group, two types of samples of prepared. In one type, biochar was milled into particulates having a size in the range of 23-88 μm prior to being coated with a catalyst. A slurry was made by dispersing fine biochar particles in a liquid solution containing iron nitrate dissolved in ethanol. The slurry was then spray dried to obtain individual biochar particles coated with iron nitrate. In another type, no size reduction of biochar was conducted and the biochar was simply immersed in iron nitrate, followed by drying in an oven overnight.

In a typical procedure, the mixture was placed in a tube furnace and heated to 900° C. at a ramping rate of 5° C./min and held for 1 h. To create an inert atmosphere, N2 gas was flowed through the furnace throughout the heat treatment. The mixture containing a catalyst was then heated at 1,350° C. for 3 hours. In some control samples, the mixtures were graphitized in a box-type furnace equipped with graphite heating elements. Graphitization was conducted at 2,300° C. (e.g., Sample 1-B-1) for 3 h under the protection of a flowing helium gas. The carbon yield was obtained by measuring and calculating the amount of carbon powder (minus GO amount) divided by the original biomass particle weight. The degree of graphitization was calculated by using the Merling's equation based on X-ray diffraction data. Testing data are summarized in Table 1 below.

TABLE 1
Testing data (Tca = carbonization temperature; Tgr = graphitization temperature)

| | | | Graphene | Catalyst for | | | |
|---|---|---|---|---|---|---|---|
| Sample | % | Type of | doping or | graphitization of | Tca (° C.); | Carbon | Degree of |
| ID | GO | biomass | coating | biochar | Tgr (° C.) | yield | graphitization |
| 1-A-1 | 0 | glossy | none | none | Tca = 350 | 21.6% | Not graphitizable |
| | | privet | | | | | without catalyst |
| 1-A-2 | 0 | glossy | none | Fe | Tca = 350 | 21.6% | 82% |
| | | privet | | | Tgr = 1,350 | | |
| 1-A-3 | 0.1 | glossy | none | Fe | Tca = 350 | 28.5 | 93% |
| | | privet | | | Tgr = 1,350 | | |
| 1-B-1 | 0.01% | glossy | none | none | Tca = 350 | 25.4% | 60.7% |
| | | privet | | | Tgr = 2,300 | | |
| 1-B-2 | 0.01% | glossy | none | Immersion of | Tca = 350 | 25.4% | 85% |
| | | privet | | biochar in Fe | Tgr = 1,350 | | |
| | | | | nitrate solution | | | |
| 1-B-3 | 0.01% | glossy | none | Fe coated on | Tca = 350 | 25.4% | 92.5% |
| | | privet | | small biochar | Tgr = 1,350 | | |
| | | | | surfaces | | | |
| 1-D-1 | 1% | glossy | B coating | Fe nitrate | Tca = 350 | 32.5 | 78.7% |
| | | privet | | solution | Tgr = 1,350 | | |
| | | | | immersion | | | |
| 1-D-2 | 1% | glossy | B coating | Fe coated on | Tca = 350 | 32.5% | 94.3% |
| | | privet | | small biochar | Tgr = 2,300 | | |
| | | | | surfaces | | | |

It may be noted that graphene sheets added to the biomass feedstock stay as graphene sheets mixed with the biochar after the hydrothermal carbonization treatment. These data have clearly demonstrated the following:
1) Adding some graphene sheets and/or catalyst in biochar particles can significantly increase the degree of graphitization when heat-treating the mixture.
2) When both graphene sheets and the catalyst are present, one can achieve the highest degree of graphitization.
3) The post-consumer biomass can be up-cycled to some useful products, such as graphite, which can be further turned into an anode active material for lithium-ion batteries.

### Example 2: Conversion of Lignin to Biochar and then to Graphitic Carbon

Lignin Biomass to Biochar: Biochar was prepared from lignin by hydrothermal treatment. Lignin (14 g) was mixed with deionized water (100 mL) and placed in a high temperature, high-pressure Parr reactor. The conversion was carried out at 300° C. and 1500 psi for 30 min and, subsequently, the reactor was allowed to cool to room temperature. The biochar was readily separated from the aqueous media. Two samples were prepared: Sample 1 contained large biochar flakes (>1 mm in size) and Sample 2 contained much smaller biochar particles (<30 μm) that were produced by intensive milling.

Catalytic Graphitization of biochar: For Sample 1, catalysts were added to the biochar by a simple solution impregnation method. Specifically, Co(II) nitrate and Mn(II) nitrate were separately dissolved in ethanol to form two liquid solutions having concentrations of 0.15 Mn(II)-NO₃ and Co(II)NO₃ mole-metal/g. Biochar was dispersed in the two liquid solutions to form two separate slurry samples. After stirring for 3 hours, ethanol was removed under vacuum to form a simple mixture of metal nitrate and biochar flakes. For sample 2, smaller biochar particles were dispersed in the same liquid solutions to form slurries, which were then spray-dried to form particulates of metal nitrate-coated biochar particles.

The obtained samples were heated under argon at a heating rate of 20° C./min and kept at the graphitization temperature 1100° C. for 3 h. The samples were then cooled down to room temperature and each sample was divided up into two specimens per sample. In one specimen (Specimen 2-A), the product was washed with 10% (w/w) HCl to remove catalysts. In the other specimen (Specimen 2-B), the catalyst was allowed to stay with graphite, but the specimen was heated to produce manganese oxide and cobalt oxide, respectively.

The graphite materials prepared under differing conditions were made into anode electrodes and then each combined with a separator layer, a piece of lithium metal, and EC/VC liquid electrolyte to form a button cell according to well-known standard cell production procedures. The cells were then tested with a 0.01C, 0.05C, and 0.3C rates. The data on the degree of graphitization, 1^{st}-cycle efficiency, and specific capacities at 1^{st} and subsequent cycles were summarized in Table 2 below:

TABLE 2
Testing data (Tca = carbonization temperature; Tgr = graphitization temperature)

| | | | | 1^{st}-cycle Coulombic |
|---|---|---|---|---|
| Sample | | | Degree of | efficiency; 1^{st} and 10^{th} cycle |
| ID | Catalyst for graphitization of biochar | Tgr (° C.) | graphitization | specific capacity (mAh/g) |
| S1-A-1 | Co (Immersion of biochar in Co | 1150 | 83.4 | 79.2%; 422 → 213 |
| | nitrate solution); catalyst removed | | | |
| | after graphitization | | | |
| S1-A-2 | Mn (Immersion of biochar in Mn | 1250 | 85.2% | 81.3%; 411 → 242 |
| | nitrate solution); catalyst removed | | | |
| | after graphitization | | | |
| S2-A-1 | Co coated on surfaces of small | 1150 | 93% | 89.8%; 358 → 344 |
| | biochar particles; catalyst removed | | | |
| | after graphitization | | | |
| S2-A-2 | Mn coated on surfaces of small | 1250 | 94.7% | 90.2%; 356 → 352 |
| | biochar particles; catalyst removed | | | |
| | after graphitization | | | |
| S2-B-1 | Co coated on surfaces of small | 1150 | 93% | 88.5%; 475 → 452 |
| | biochar particles; metal oxide formed | | | |
| | in situ after graphitization | | | |
| S2-B-2 | Mn coated on surfaces of small | 1250 | 94.9% | 89.9%; 469 → 460 |
| | biochar particles; metal oxide formed | | | |
| | in situ after graphitization | | | |

These data have demonstrated that the graphite anode materials (e.g., Samples S2-A-1 and S2-A-2) prepared from small biochar particles uniformly coated a catalyst exhibit much higher 1^{st}-cycle efficiency and more stable cycling behaviors, as compared to samples prepared by simply immersing large biochar chips in a catalyst precursor solution; e.g., approximately 90% vs. 80% and decay of capacity from 358 to 344 mAh/g vs. from 422 to 213 mAh/g. Furthermore, by retaining Co and Mn in the graphite (not removing them) and converting Co and Mn into metal oxides, one obtained much higher specific capacity values and stable cycling.

### Example 3: Preparation of Graphene Sheets from Meso-Carbon Micro-Beads (MCMBs) and Graphene/Catalyst-Assisted Production of Graphite from Non-Lignocellulosic Biomass (e.g., Chitosan)

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulphate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours. The slurry was then dried and strayed using a spray dryer to obtain slightly reduced GO sheets (RGO).

Chitosan is an abundant type of biomass (e.g., from shrimp shell). Chitosan may be converted into graphite with or without using a catalyst. In the present study, a two-step procedure was conducted, which included using FeCl₃ as a catalyst in the thermal conversion of a chitosan/FeCl₃ mixture to a biochar. In a typical process, chitosan and FeCl₃ were mixed in deionized (DI) water and dried at 80° C. to obtain a brown chitosan/FeCl₃ mixture. Then, the mixture was heated in a sealed furnace under Ar atmosphere at 400° C. for 2 hours to generate a powder mixture. The sample was dried overnight in a vacuum oven at 60° C. to and then subjected to air-jet milling to form solid powder of a biochar having an average particle size of 33 μm. A separate powder sample was prepared without air-jet milling.

For subsequent graphitization, a sample (3-A) was prepared without adding additional Fe. A second sample (3-B) was prepared by immersing solid biochar chips (without air-jet milling) in an iron nitrate solution, followed by drying. A third sample (3-C) was prepared by immersing solid biochar chips (without air-jet milling) and RGO sheets in an iron nitrate solution, followed by drying. A fourth sample was prepared by mixing finer biochar particles and graphene sheets in an iron nitrate-water solution, followed by spray-drying to obtain iron nitrated-coated particulates. The iron nitrate was thermally converted to Fe metal during the subsequent heat-treating (temperature rising) step prior to reaching the graphitization temperature. After graphitization treatment for 3 hours for 3 hours for all samples, the powder was immersed in 1 M HCl for 1 hour to remove the Fe. The data summarized in Table 3 below again clearly demonstrate that adding some graphene sheets and a catalyst in pieces of biochar can significantly increase the degree of graphitization of the graphite products produced. The best results were achieved if the biochar were reduced in sizes and uniformly coated with the catalyst.

TABLE 3
Testing data (Tca = carbonization temperature; Tgr = graphitization temperature)

| Sample | % | | Tca (° C.); | Degree of |
|---|---|---|---|---|
| ID | RGO | Additional catalyst for graphitization of biochar | Tgr (° C.) | graphitization |
| 3-A | 0 | No additional catalyst during graphitization | Tca = 800 | 56.4% |
| | | | Tgr = 2,500 | |
| 3-B | 0 | Fe (immersion of biochar and graphene sheets in Fe | Tca = 800 | 85.4% |
| | | nitrate solution) | Tgr = 1,250 | |
| 3-C | 5% | Fe (immersion of biochar and graphene sheets in Fe | Tca = 800 | 88.3% |
| | | nitrate solution) | Tgr = 1,250 | |
| 3-D | 5% | Fe (coated on surfaces of smaller biochar particles | Tca = 800 | 93.4% |
| | | and graphene sheets) | Tgr = 1,250 | |

### Example 4: Preparation of Graphite from Lignocellulosic Biomass (e.g., Kraft Lignin) with Pristine Graphene Sheets

Pristine graphene sheets were produced by using the direct ultrasonication or liquid-phase production process. In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements.

The Kraft lignin with iron ions was prepared by the co-precipitation method. In a representative procedure, thirty (30) grams of Kraft lignin was first added to 30 mL tetrahydrofuran in a glass beaker and stirred for 2 h. Separately, 25 grams of iron(III) nitrate was added to 20 mL DI water in a smaller glass beaker and the mixture was stirred until dissolved completely. Subsequently, the iron nitrate solution was added drop-wise to the Kraft lignin solution and stirred for 2 h. The mixture was sealed in an autoclave and heated at 190° C. for 5 hours. The resulting biochar mixture was transferred to an oven where it was dried at 80° C. for 24 h. These particles, along with 2.0% by weight of pristine graphene and an amount of Mn nitrate, were mixed and dried. The dried powder was packed in the middle of a 1-inch OD, stainless steel tubular reactor. The reactor was heated at a rate of 10° C./min to 1,500° C. and maintained at 1,500° C. for 3 h. Then, the furnace was cooled down at a rate of 10° C./min to room temperature. The resultant graphite product as divided up into two samples. In one sample (4-A), the catalyst was removed from graphite. In the other sample (4-B), the graphite product was re-heated to 500° C. to obtain graphite containing approximately 8.5% by weight of Mn₃O₄ nano particles dispersed in the graphite matrix. The two samples were incorporated as an anode into two separate button cells having lithium metal as a counter electrode. The first-cycle efficiency and specific capacity of each cell were measured.

The data summarized in Table 4 below further demonstrate that the first-cycle efficiency of the cell containing an anode comprising graphite and approximately.

TABLE 4
Testing data (Tca = carbonization temperature; Tgr = graphitization temperature)

| Sample | % | Additional catalyst for | Tca (° C.); | Degree of | 1^{st}-cycle efficiency and |
|---|---|---|---|---|---|
| ID | graphene | graphitization of biochar | Tgr (° C.) | graphitization | capacity |
| 4-A | 2% | Mn (Metal removed by | Tca = 180 | 88.2% | 83.3%; 335 mAh/g |
| | | acid immersion after | Tgr = 1,500 | | |
| | | graphitization) | | | |
| 4-B | 2% | Mn (Oxidized after | Tca = 180 | 88.2% | 83.2%; 424 mAh/g |
| | | graphitization) | Tgr = 1,500 | | |

### Example 5: Preparation Graphite from Lignocellulosic Biomass (e.g., Cellulose) Assisted by a Catalyst and Graphene Fluoride (as an Example of Halogenated Graphene)

Several processes have been used by us to produce GF, but only one process is herein described as an example. In a typical procedure, highly exfoliated graphite (HEG) was prepared from intercalated compound C₂F·xClF₃. HEG was further fluorinated by vapors of chlorine trifluoride to yield fluorinated highly exfoliated graphite (FHEG). % Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

The precursor cellulose was prepared by mechanical milling. In a representative process, 50 g of bleached kraft pulp was loaded to a 500 ml PTFE pot containing zirconia balls of three size and numbers: 2 of 20 mm diameter, 100 of 10 mm diameter, and 300 of 6 mm diameter (631 g in total). Milling was conducted by a planetary ball mill at 300 rpm for 24 h. The obtained milled sample was mixed with graphene fluoride powder (20/1 ratio) in a nickel acetate-water solution. In another example, no nickel was introduced. The mixtures were dried and calcined in a furnace at a temperature (700° C.) for 1 h with a heating rate of 10° C./min under a nitrogen atmosphere. The carbonized sample was further treated at a temperature of 2,300° C. The addition of 2% by weight of graphene fluoride was found to increase the degree of graphitization from 75% to 87%. With 3.5% Ni, the degree of graphitization was 93%.

### Example 6: Nitrogenated Graphene-Assisted Preparation of Graphite from Mixed Lignocellulosic/Non-Lignocellulosic Biomass

Graphene oxide (GO), synthesized in Example 2, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene:urea mass ratios of 1:0.5, 1:1 and 1:2 are designated as NGO-1, NGO-2 and NGO-3 respectively and the nitrogen contents of these samples were 14.7, 18.2 and 17.5 wt % respectively as found by elemental analysis.

Sugarcane bagasse pith was obtained by squeezing and extracting sugarcane juice from the sugarcane purchased from a supermarket. Then, the sugarcane bagasse pith (5 g) was suspended in 500 ml of distilled water containing 1 wt % glacial acetic acid dissolved therein. Chitosan (2.14 g) was then added into the acetic solution with continuous stirring until chitosan was completely dissolved. The resulting suspension was stirred for about 5 h at room temperature, and dried at 80° C. in an oven. The sugarcane bagasse pith/chitosan mixture was first heat-treated in an autoclave (180° C. at 2 atm pressure) for 1 hr. The resulting partially carbonized mass was mixed with 5% nitrogenated graphene sheets and nickel nitrate and the mixture was heated in a tube furnace for 1 h at 1,400° C. in Ar atmosphere with a ramp rate of 10° C./min to obtain a sample of biochar-derived graphite particles. The addition of 5% by weight of nitrogenated graphene and 3% Ni was found to increase the degree of graphitization from less than 76% to 93.6%.

1. A feedstock composition of matter comprising a mixture of biochar, a catalyst, and discrete graphene sheets, wherein the composition comprises:
(a) a catalyst content of between about 0.1 and 30 percent by weight;
(b) a biochar particulate content of between 65 and 99.8 percent by weight, having a biochar particulate size less than 1 mm; and
(c) a graphene content either (i) from 0 to 30 percent by weight, if the catalyst is in a form of coating uniformly coated on the surfaces of biochar particulates, or (ii) from about 0.1 to 30 percent by weight;
wherein the catalyst comprises a metal, a metal alloy, a metal compound, boron (B), phosphorus (P), tin (Sn), or a combination thereof; and the graphene sheets comprise single-layer or few-layer graphene, having 2-10 graphene planes, selected from pristine graphene, having a carbon content greater than 99%, graphene oxide, reduced graphene oxide, halogenated graphene, nitrogenated graphene, hydrogenated graphene, doped graphene, chemically functionalized graphene, or a combination thereof.

2. The composition as defined in claim 1, wherein one or more of the following apply: (i) the catalyst content in the mixture is in particulate form; (ii) the catalyst content in the mixture is in a thin coating form deposited on a surface of the graphene sheets; and (iii) the catalyst content in the mixture is in a thin coating form deposited on a surface of the biochar particulates.

3. The composition as defined in claim 1, wherein one or more of the following apply: (i) the graphene content is from about 1 to about 10 percent by weight; (ii) the biochar is from 75 to 99 percent; and (iii) the catalyst content is from 1 to 7 percent.

4. The composition as defined in claim 1, wherein the biochar content is derived from heating a biomass feedstock to temperatures of between about 150 and 1500 degrees Celsius and the biomass feedstock comprises a material selected from a lignocellulosic biomass or non-lignocellulosic biomass, wherein the lignocellulosic biomass comprises cellulose, hemicellulose, lignin, a chemical derivative thereof, or a combination thereof and non-lignocellulosic biomass comprises a carbohydrate, polysaccharide, protein, a chemical derivative thereof, or a combination thereof.

5. The composition as defined in claim 4, wherein said lignocellulosic biomass is selected from wood waste, cellulose, miscanthus, peanut shell, mangrove, polar wood chip, oil palm fiber, bamboo stick, polar lignin, plane tree fruit, Typha orientalis, sawdust, softwood sawdust, oak sawdust, alginate, bengal gram bean husk, sodium alginate, coconut shell, mangrove charcoal, pine nut shell, sugarcane bagasse pith, chitosan, Kraft pulp, natural cellulose paper, cellulose-based fiberboard, hydroxypropyl cellulose, methylcellulose, sodium lignosulfonate, Kraft lignin, onion peels, camphor leaves, seaweed, wheat straw, or a combination thereof.

6. The composition as defined in claim 4, wherein said non-lignocellulosic biomass is selected from food waste, fruit or vegetable waste, kitchen waste, fruit, agro-food waste, bone waste, biopolyol, glucose, egg yolk, Okara, Coprinus comatus, chitosan, almond, peanut dregs, glossy privet, sucrose, pear, or a combination thereof.

7. The composition as defined in claim 1, wherein one or more of the following apply: (i) the metal is a transition metal; and (ii) the metal compound comprises a salt of a transition metal.

8. The composition as defined in claim 1, wherein the metal, metal alloy, or metal compound comprises a transition metal selected from chromium, zirconium, molybdenum, ruthenium, rhodium, palladium, silver, cadmium, zinc, copper, nickel, cobalt, iron, manganese, chromium, vanadium and any combination thereof

9. The composition as defined in claim 1, wherein the doped graphene comprises graphene sheets doped or coated with element B, P, Sn, Ti, V, Cr, Mn, Fe, Co, Ni, Cu, Zn, Zr, Nb, Mo, Ru, Pd, Ag, Cd, Pt, Au, a chemical species selected from PdCl₂, FeCl₃, FeBr₃, FeF₃, NiBr₂, NiI₂, Cs₂CO₃, CsF, CsCl, CsBr, CH₂Cl₂, FeSiO₃, CuSiF₆, CuCl₂, CuF₂, CuO, B₄C, or a combination thereof.

10. The composition as defined in claim 1, wherein one or more of the following apply: (i) the biochar component has a particulate size of less than about 0.5 mm; and (ii) the catalyst component has a particulate size or coating thickness of less than about 5 μm.

11. A method of producing crystalline graphite from the feedstock composition as defined in claim 1, said method comprising:
A) providing the feedstock composition, comprising a mixture of biochar, a catalyst, and discrete graphene sheets; and
B) heat-treating said composition at a graphitization temperature for a period of time sufficient to produce a crystalline graphite product having a graphite content higher than 65% by weight, wherein the graphitization temperature is selected from 400° C. to 3,200° C.

12. The method of claim 11, wherein the catalyst comprises an element or chemical species selected from B, P, N, Ti, V, Cr, Mn, Fe, Co, Ni, Cu, Zn, Zr, Nb, Mo, Ru, Pd, Ag, Cd, Pt, Au, PdCl₂, FeCl₃, FeBr₃, FeF₃, NiBr₂, NiI₂, Cs₂CO₃, CsF, CsCl, CsBr, CH₂Cl₂, FeSiO₃, CuSiF₆, CuCl₂, CuF₂, CuO, B₄C, a metal nitrate, metal acetate, metal sulfate, metal phosphate, metal hydroxide, metal carboxylate, or a combination thereof.

13. The method of claim 11, wherein the catalyst is coated on surfaces of biochar particulates or on surfaces of the graphene sheets, wherein the graphene sheets have a specific surface area from 20 to 3,200 m²/g when measured without the catalyst.

14. The method of claim 11, wherein surface of the biochar and/or the surfaces of graphene sheets are coated with a polynuclear hydrocarbon material.

15.-24. (canceled)

25. A method of producing a crystalline graphite-based anode material, said method comprising (a) providing a feedstock mixture comprising particles of biomass and/or biochar and from 0.1% to 40% by weight of a catalyst, wherein the catalyst is selected from Sn, a Sn alloy, a transition metal, a transition metal alloy, a compound containing Sn, a compound comprising a transition metal, or a combination thereof; (b) heat-treating the feedstock mixture at a graphitization temperature for a period of time sufficient to produce a crystalline graphite product comprising a mixture of Sn or said transition metal and crystalline graphite, wherein the graphitization temperature is selected from 400° C. to 3,200° C.; and (c) converting said Sn or transition metal to SnO₂ or a transition metal oxide to produce said anode material comprising crystalline graphite and said transition metal oxide or SnO₂.

26. The method of claim 25, wherein the feedstock mixture comprises from 1% to 20% by weight of said catalyst and/or the transition metal is selected from Ti, V, Cr, Mn, Fe, Co, Ni, Cu, Zn, Zr, Nb, Mo, Ru, Pd, Ag, Cd, Pt, Au, or a combination thereof.

27. The method of claim 25, wherein the anode material, when used in a lithium-ion cell, delivers a specific capacity value higher than a specific capacity of the crystalline graphite without said metal oxide or SnO₂.

28. A composition of matter comprising a mixture of crystalline graphite, a catalyst metal, isolated graphene sheets, not part of a graphite structure, and biochar, with (a) a crystalline graphite content of from about 70% to 99% by weight, (b) a metal content from about 0.1% to about 15% by weight, (c) a biochar content from about 0.1% to about 10% by weight, and (d) isolated graphene sheet content from about 0.1% to about 5% by weight.

29. The composition of claim 28, wherein one or more of the following apply: (i) the crystalline graphite content in the mixture is in particulate form; (ii) the biochar content in the mixture is in particulate form having a size smaller than 500 μm; (iii) the metal content comprises metal on a graphite surface or embedded in a graphite particulate; and (iv) the metal content in the mixture comprises a metal oxide.

30. The composition of claim 28, wherein one or more of the following apply: (i) the crystalline graphite content is greater than 75% by weight; (ii) the biochar content is less than 5%; and (iii) the metal content is less than 5%.
